(19) United States
(12) Patent Application Publication
(10) Pub. No.: US 2025/0378509 A1
(43) Pub. Date: Dec. 11, 2025

(54) AUTOMATED METHODS AND SYSTEMS FOR MODELLING GEOSPATIALLY SPECIFIC LOAD GROWTH

(71) Applicant: Deloitte Inc., Toronto (CA)

(72) Inventors: Barbar MOAWAD, Vancouver (CA); Kevin LAVEN, Toronto (CA); Sarah DE LAZZARI, San Francisco, CA (US); Daniel MERLANO, Bright's Grove (CA); Ronan Dinsmore GARRISON, North Vancouver (CA)

(21) Appl. No.: 18/736,376

(22) Filed: Jun. 6, 2024

(51) Int. Cl. G06Q 50/06

(52) U.S. Cl. CPC G06Q 50/06

(57) ABSTRACT

Methods and systems are provided for assessing the effects of an adopted technology on power demands on an electrical grid. An estimate of a rate of deployment for the adopted technology in a target utility area is determined over a predetermined time period. An estimate of a total stock of the adopted technology in one or more dissemination areas is determined by geospatially disaggregating the estimated rate of deployment of the adopted technology across the one or more dissemination areas. The estimated total stock of the adopted technology is derived from a forecasted energy consumption profile for one or more subareas within the target utility area. The forecasted energy consumption profiles are integrated with current consumption profiles for display in a graphical user interface.

### TECHNICAL FIELD

The present disclosure relates generally to utility management, and in particular to systems and computer-implemented methods for forecasting load growth in an electrical grid from the adoption of electro-technologies.

### BACKGROUND

The global shift towards renewable energy sources has led to the emergence of electro-technologies (i.e., technologies that rely on electricity to operate) that can effectively harness, store, and distribute cleaner forms of energy. With electrification being accepted as one of the more effective ways to reduce emissions, many end-uses have started to adopt electricity consuming technologies. Some examples of electro-technologies include wind turbines, light-emitting diodes (LEDs), electric vehicles (EVs), photovoltaics (PVs), and high-efficiency heat pumps (HPs). Such technologies are generally more environmentally friendly than those relying on traditional power sources such as coal, oil and gas, and are also capable of providing high overall performance, high energy efficiency, and long-term cost savings.

The adoption of electro-technologies can have a significant impact on demands for electricity and the overall load on an electrical grid. In particular, distributed energy resources (DERs) and power-intensive technologies can introduce complications with respect to grid stability, grid reliability, and grid management. Unlike traditional power supplies which deliver one-way flow of electricity from central power plants to consumers, DERs introduce bi-directionality, offering both an off-grid mode to supply power locally and an on-grid mode to deliver excess power back to the grid and/or draw power from the grid when the local generation is insufficient. These technologies, along with other electricity consuming technologies (e.g., EVs, HPs, etc.), could impact electricity infrastructure in ways that utility providers have not had to grapple with in the past. As the output and draw of technologies like DERS, EVs, HPs tend to be variable and unpredictable (e.g., due to their reliance on unpredictable consumer behaviors and renewable temperature or weather-dependent sources such as solar and wind), there is a need for accurate load forecasting solutions that can predict how the adoption of such technologies would affect the balance of supply and demand on an electrical grid.

Existing electrical grid load forecasting techniques typically rely on historical averaging. Such techniques, used in connection with traditional power sources, do not account for new consumption behaviours and are generally incapable of predicting how the widespread adoption of electro-technologies could affect future demand on grid power. As a result, some utility companies have recently began to engage in more sophisticated load forecasting exercises by adopting various econometric and end-use modelling approaches. These approaches tend to require multiple steps and long processes involving macroeconomic energy demand analysis. The entire process can take years to complete, and often results in the creation of modelling outputs with inconsistent assumptions. Other approaches are designed to forecast load demand changes within specific stages of the electro-technology adoption process. Such approaches can be effective in some cases, but fail to provide an integrated solution for the entire process.

There remains a need for new load forecasting solutions that are designed to facilitate the adoption of emerging electro-technologies in a target utility area. In particular, there remains a need for solutions that can assess the load impacts of DERs and power-intensive technologies on an electrical grid's distribution infrastructure, including its neighborhood circuits and substations. There remains a need for integrated models that can provide utilities with the tools necessary to assess geospatially specific load growth, develop infrastructure plans within shorter timelines than the status quo, deploy capital more effectively for infrastructure upgrades, and/or accelerate alignment with key stakeholders including regulators, policymakers, and other utilities. There remains a need for systems and computer-implemented methods which address the aforementioned challenges associated with determining how the adoption of a new technology, such as electric vehicles (EVs), solar photovoltaics (PVs), and heat pumps (HPs), in a geospatial region would affect power demands on an electrical grid.

### SUMMARY OF THE DISCLOSURE

One aspect of the invention relates to a computer-implemented method for assessing the effects of an adopted electro-technology on power demands on an electrical grid. The method involves receiving forecasted and historical data for the adopted electro-technology, and estimating a rate of deployment for the adopted technology in a target utility area over a predetermined time period based on the forecasted and historical data. A total stock of the adopted technology in one or more dissemination areas is estimated by geospatially disaggregating the estimated rate of deployment of the adopted technology across the one or more dissemination areas. From the estimated total stock of the adopted technology, a forecasted energy consumption profile is derived for subareas within the target utility area. The forecasted energy consumption profiles are integrated with current consumption profiles for display in a graphical user interface. The integrated forecasted energy consumption profile may be overlaid onto a digital model of the electrical grid.

In some embodiments, the rate of deployment of the adopted technology is estimated via deployment models. The deployment models may be updated periodically. In some embodiments, the adopted technology is classified, and the rate of deployment of the adopted technology is estimated based on a deployment model selected via the classification of the adopted technology. In some embodiments, the estimated rate of deployment for the adopted technology is determined from an estimated increase in total stock of the adopted technology in the target utility area over the predetermined time period.

In some embodiments, the dissemination areas are defined according to behavioral data and geospatial data collected from within parts of the target utility area. In some embodiments, the one or more subareas area are defined on a circuit level or a substation level. In some embodiments, the target utility area is defined on a city level or a postal code level.

In some embodiments, the forecasted energy consumption profile is derived from the estimated total stock of the adopted technology based on a bottom-up circuit-level load forecast approach. In some embodiments, the forecasted energy consumption profile is derived from the estimated total stock of the adopted technology based on a bottom-up substation-level load forecast approach.

Other aspects of the invention relate to systems for assessing the effects of an adopted electro-technology on power demands on an electrical grid. The system comprises a server in communication with one or more databases. The server receives forecasted and historical data from the databases and is configured to assess the effects of an adopted electro-technology on power demands on an electrical grid in accordance with the computer-implemented methods described herein.

In addition to the exemplary aspects and embodiments described above, further aspects and embodiments will become apparent by reference to the drawings and by study of the following detailed descriptions.

### BRIEF DESCRIPTION OF THE DRAWINGS

Features and advantages of the embodiments of the present invention will become apparent from the following detailed description, taken with reference to the appended drawings in which:

FIG. 1 is a flowchart of a method for determining the effects of an adopted technology on power demands on an electrical grid according to an example embodiment;

FIGS. 2A, 2B, 2C, 2D and 2E (collectively, FIG. 2) depict an exemplary graphical user interface (GUI) that may be provided as part of the FIG. 1 method to display various integrated load profiles in response to new technology adoption; and

FIG. 3 is a block diagram of various exemplary modules that may be programmed or otherwise configured to implement the FIG. 1 method.

### DETAILED DESCRIPTION

The description which follows and the embodiments described therein are provided by way of illustration of examples of particular embodiments of the principles of the present invention. These examples are provided for the purposes of explanation, and not limitation, of those principles and of the invention.

Aspects of the invention relate to computer-implemented methods for enabling a modular approach to the infrastructure planning process. The methods combine economically constrained energy system models (e.g., energy-economy modelling) with physically constrained energy system models (e.g., load flow modelling in an accurate digital model of the electricity supply infrastructure) to provide integrated models that can be used by stakeholders in the utility sector for applications such as transmission and distribution infrastructure planning, integrated resource planning, load forecasting, rate case approvals, grid modernization analyses, rules and regulations development, and policy analysis and evaluations.

The computer-implemented methods may incorporate various models. In one example application, a first model geospatially disaggregates regionwide emerging energy consuming technology adoption to a neighborhood level and/or meter level of granularity, and a second model utilizes the output(s) of the first model to forecast temporally detailed (e.g., hourly, sub-hourly, etc.) energy consumption profiles of electricity grids within the region. The integration of the two models allows the method to account for both geospatially-specific dynamics and macroeconomic dynamics. Optionally, a third model can ingest the geospatially disaggregated loads and overlay them onto a digital model of an electricity grid. The overlaid model can help the utility industry identify how the adoption of new technologies could affect the power capacity of electrical grid components and the associated power quality.

Throughout this specification, numerous terms and expressions are used in accordance with their ordinary meanings. Provided immediately below are definitions of some terms and expressions that are used in the description that follows. Definitions of some additional terms and expressions that are used are provided elsewhere in the description.

“Distributed energy resource” or “DER”, as used herein, refers to a small-scale electricity generation or storage resource that is interconnected with the electrical grid, typically through the lower-voltage distribution grid. DERs are generally situated near sites of electricity use. Examples of DERs include electric vehicles, solar panels or photovoltaics, batteries, microturbines, small wind farms, and the like.

“Electro-technology”, “newly adopted technology”, “adopted technology” or “new technology” are used interchangeably herein to refer to electricity consuming or electricity producing technologies that have been adopted recently or in growing numbers, such that they have an impact on the electrical grid. These types of technologies include DERs, heat pumps, electric water heaters, electric compressors, LEDs, etc.

“Bottom-up approach”, as used herein, refers to the approach of aggregating data from the substation or circuit level to create an overall load impact for the city. “Top-down approach”, as used herein, refers to the approach of aggregating data at the city level to infer behaviours at the neighbourhood, substation, or circuit level.

“Geospatial disaggregation”, as used herein, refers to the process of dividing large datasets into smaller datasets, based on geographic regions or geographic characteristics. “Dissemination area”, as used herein, refers to a relatively stable geographic unit composed of one or more adjacent dissemination blocks and corresponding to a standard geographic area for reporting census data, demographic data, or other similar types of aggregated data. Dissemination areas may be defined by a government organization in some countries.

“Stock”, as used herein, refers to the total number of measured units in a given point of time. For example, the total number of electric vehicles registered in a particular region on a particular date is referred to as a stock of electric vehicles. The stock is distinct from the “flow” of such measured units. The flow is measured over an interval of time. For example, the flow of electrical vehicles may be the number of new electric vehicles registered or the number of electric vehicles retired over a given year.

“Diffusion model”, as used herein, refers to a data-intensive ‘S-curve’ econometric model that uses the concept of imitators, innovators, and market size, to forecast technological adoption trends. Imitator and innovator metrics are determined by underlying economic parameters that influence consumer behavior, technologic advancements, policy/regulation, etc. Diffusion models may be used herein to geographically disaggregate technology adoption bottom-up (as opposed to top-down).

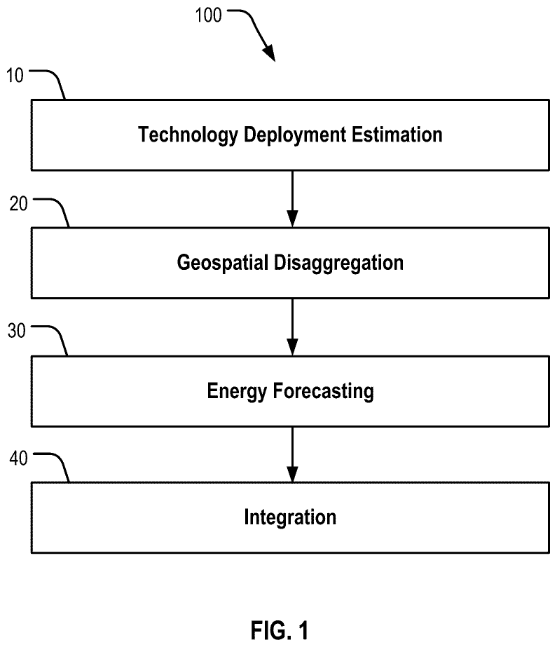

Referring now to FIG. 1, shown therein is a flowchart of an exemplary computer-implemented method 100 for determining the effects of a newly adopted technology, such as distributed energy resources (DERs), on power demands on an electrical grid. Method 100 may be used to facilitate the widespread adoption of one or more types of electro-technologies within a target utility area. For example, method 100 may be used to forecast peak loads within a target utility area (or various subareas therein) in response to the adoption of electric vehicles (EVs), solar photovoltaics (PVs) and/or heat pumps (HPs) within the target utility area. For the purposes of facilitating the description, the term “target utility area” is used herein to refer to a utility area of interest, such as a city, a town, a district, etc.

Method 100 begins at technology deployment estimation step 10. Step 10 comprises estimating a rate of deployment of a newly adopted technology in a target utility area over a predetermined period of time. The rate of deployment in the target utility area may be estimated from regionwide adoption trends, expected regionwide flow of the adopted technology, technology market share data, and other historical or forecasted data. The predetermined period of time may range from one (1) year to ten (10) years or more in weekly, monthly, annual or multi-year increments. As an example, a ten-year, forward-looking, period may be selected as the predetermined period of time when method 100 is used to facilitate the deployment of new HPs in a target utility area. Other predetermined time periods may be used for other types of electro-technologies and/or depending on an intended user's preferences or requirements. Depending on the type or nature of the new technology, step 10 may rely on one or more different methods to estimate the new technology's rate of deployment.

For example, adjusted annual EV stock forecasts may be estimated in step 10 by using one or more deployment models, including one or more macroeconomic energy-economic models. Such models may, for example, estimate the propensity of adopting an EV based on the cost of ownership of the vehicle relative to other vehicles or technologies available to the purchase. In general, the models may be developed or otherwise configured to account for an adjusted annual total stock of vehicles and an adjusted annual market share for EVs. The adjusted total stock of vehicles each year may be determined from a stock turnover model, or by using a different stock estimation approach to estimate how new EV stock and retiring EV stock affect the overall makeup of EV adoption. The adjusted EV market share each year may be determined by applying one or more EV growth models to a previous year's EV market share. Actual vehicle stock and EV market share data in a current year can be retrieved from external databases and used as a basis for determining the immediate following year's adjusted total stock of vehicles and EV market share.

As another example, annual forecasted solar photovoltaic (PV) deployment rates may be estimated in step 10 by using models, such as diffusion models, that simulate the likelihood of building residents or owners adopting PV technology based on metrics describing local economic conditions. The metrics could account for electricity rates, capital costs, operating costs, discount and other interest rates, the PV technology's capacity factor, other factors which account for the target utility area's geography (e.g., coordinates, elevation, weather), etc. To perform the estimation, historical electricity prices and PV stocks can be retrieved from external databases and used as a basis for calculating, for example, the payback period that informs the diffusion model.

Other examples include incorporating various isolated energy-economy models, such as models developed for medium and heavy-duty vehicles which can simulate large heterogeneity and characterize this transportation section. Since the type of publicly available data is different for different types of adopted technologies, step 10 may comprise classifying the adopted technology, and estimating a rate of deployment of the adopted technology by using a model selected based on the classification. In addition, since technology deployment trends can vary over time, step 10 may comprise periodically updating the deployment model for the adopted technology and estimating a rate of deployment of the adopted technology based on the periodically updated model.

After completing step 10, method 100 proceeds to geospatial distribution step 20 where the adopted technology is geospatially distributed with a disaggregation area granularity (e.g., at a neighbourhood-level of granularity). Step 20 comprises estimating the amount or level of adoption of the new technology in one or more subareas within the target utility area. Compared to target utility areas which tend to be defined at the city level, subareas tend to be defined at the neighborhood, substation, or circuit level. For each subarea, the level of technology adoption may be estimated by geospatially disaggregating the rate of deployment estimated in step 10. The estimated rate of deployment may be geospatially disaggregated across one or more predefined geographic areas.

In some embodiments, the estimated rate of deployment is geospatially disaggregated across one or more dissemination areas. Each dissemination area may comprise a plurality of dissemination blocks. The number of dissemination blocks included in each dissemination area is typically limited due to operational constraints. To avoid data suppression, each dissemination area may be delineated with boundaries enclosing a region of relatively small and uniform population size (e.g., 400 to 700 persons). The dissemination area boundaries may follow roads or other features (e.g., railways, water features, power transmission lines, etc.) which form part of the boundaries of census tracts. To the extent that census tracts typically remain stable over time, the size and shape of dissemination areas also tend to remain stable over time.

To estimate the future level of adoption of the new technology in a subarea based on the level of adoption of the new technology in the entire target utility area, step 20 may comprise determining a proportion of technology adoption attributable to the subarea and estimating future adoption counts at the subarea level based on the proportion. The proportion may be determined or estimated from relationships between historical census data (e.g., household income, dwelling type, building age, etc.) and historical technology adoption trends.

After completing step 20, method 100 proceeds to energy forecasting step 30. At step 30, the estimated total stock of the newly adopted technology is used to derive a forecasted energy consumption profile for one or more subareas within the target utility area. The forecasted energy consumption profile may be derived at step 30 with varying levels of temporal granularity, including anywhere from hours within several representative days of the year to an exhaustive account of the entire year in sub-hourly intervals. The subareas defined in step 30 may be the same or different from the subareas defined in step 20 for geospatial disaggregation. Where the subareas defined in step 30 (e.g., circuit or substation level) is different from the subareas used in step 20 (e.g., dissemination areas), step 30 may comprise establishing a mapping between the subareas of interest to forecast the appropriate energy consumption profiles.

The forecasted energy consumption profile may be derived by applying one or more models to the estimated total stock of the newly adopted technology. Since different kinds of newly adopted technologies are associated with different kinds of consumer behavior and/or weather patterns, step 30 may comprise selecting the one or more models based on the newly adopted technology and applying the selected model to the estimated total stock of the newly adopted technology. In some embodiments, step 30 incorporates a bottom-up approach to derive forecasted energy consumption profiles in one or more subareas. In some embodiments, step 30 comprises mapping the estimated total stock of the new technology in the dissemination areas to the one or more subareas.

After completing step 30, method 100 proceeds to integration step 40 where the energy consumption profiles of the subareas forecasted in step 30 are integrated together to provide the overall load impact of the new technology on the electrical grid of the target utility area. The forecasted energy consumption profiles may be integrated with current consumption profiles for display in a graphical user interface (GUI). In some embodiments, the integrated forecasted energy consumption profile is overlaid onto a digital model of the electrical grid. The digital model may be displayed (e.g., on a screen) through the GUI. The GUI may be used to help, for example, stakeholders visualize the effects of the newly adopted technology on geospatially specific load growths.

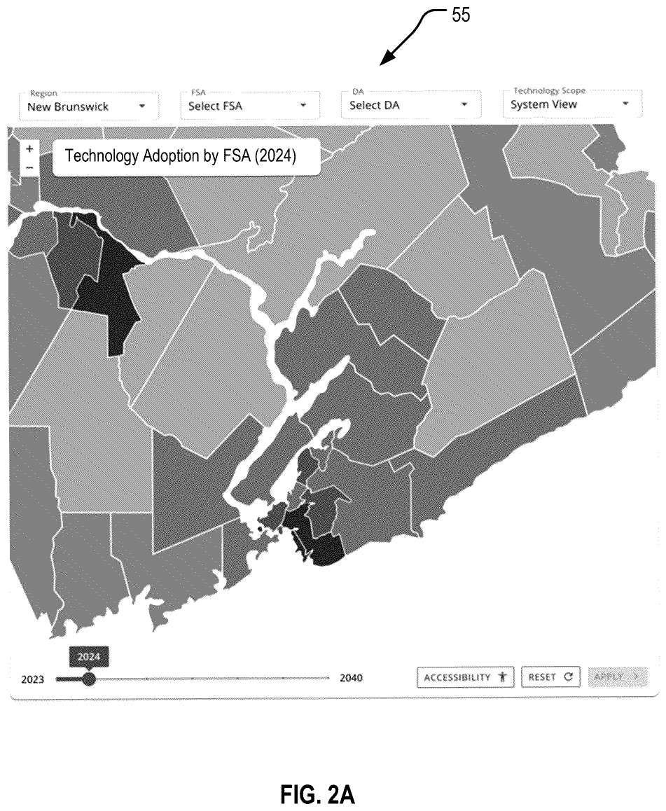

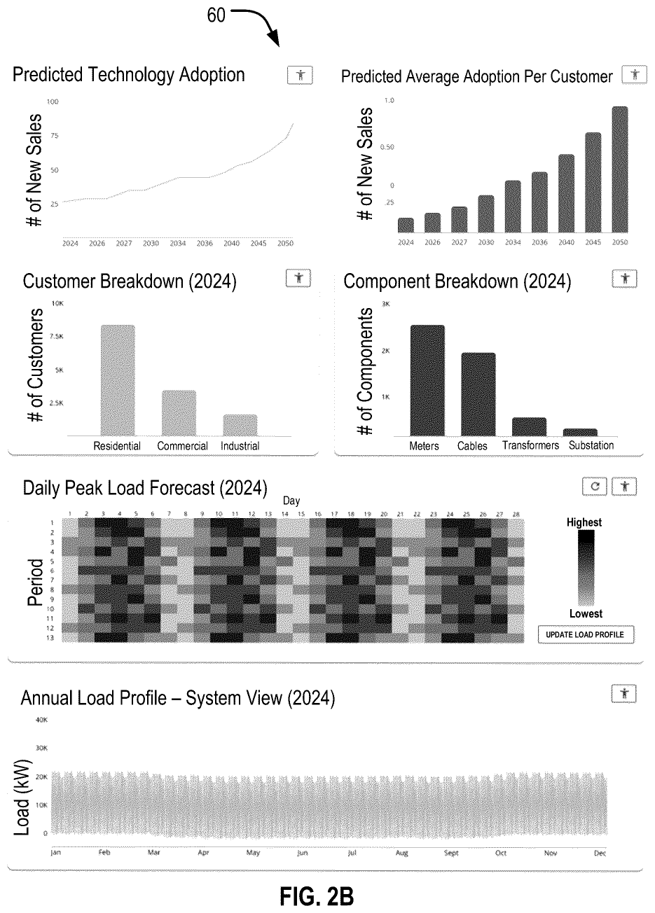

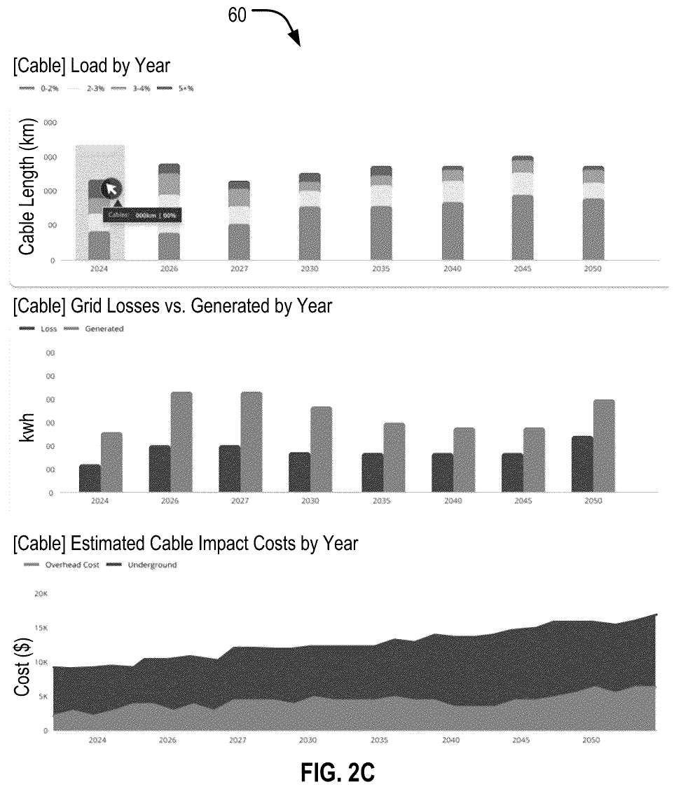

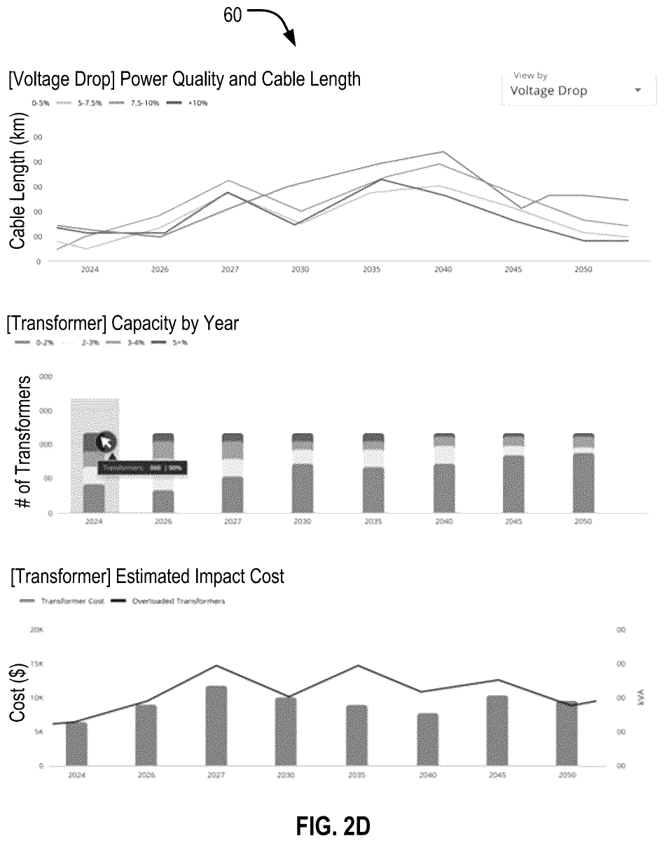

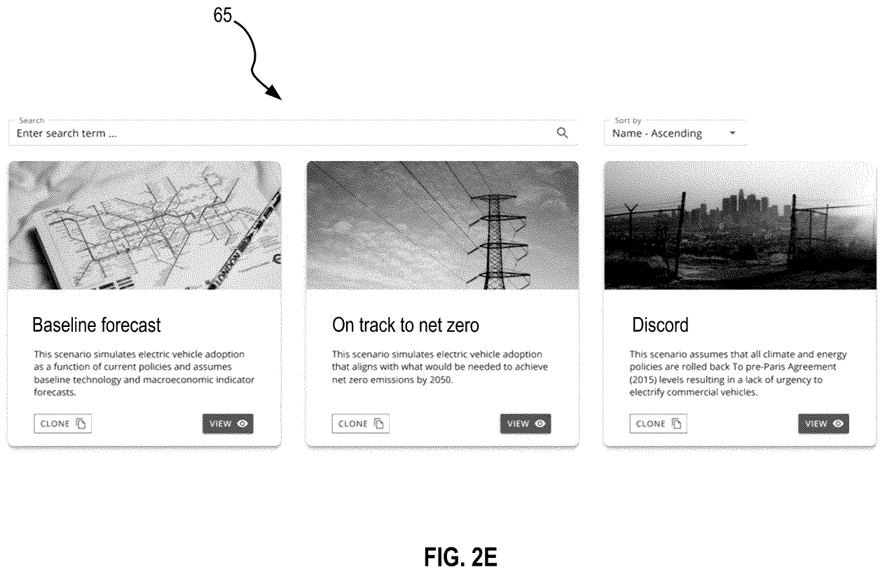

Referring now to FIGS. 2A and 2B, shown therein is an example of a GUI for displaying the overall load impact of newly adopted technologies on electrical grids, which are spread across various regions and covered under different target utility areas. The GUI can be used to illustrate the impact of newly adopted technologies under various scenarios. The GUI may include an interactive map 55 with selectable icons which allow a user to select various geographical areas of interest (e.g. regions, dissemination areas, forward sortable areas, etc.) and view the integrated load profiles in the selected area. The GUI may also include one or more display areas 60 for displaying different types of graphs and charts for different metrics associated with the integrated load profiles.

In the examples depicted in FIG. 2, a heat map, and various bar graphs, plots and charts are provided in the display areas 60 of the GUI. The types of metrics and information that may be displayed in the GUI display areas 60 include, but are not limited to, predicted levels of technology adoption, a breakdown of the number and types of customers in the selected area, a breakdown of the number and types of components (e.g., meters, transformers, cables, substations, etc.) in the selected area, cable length, grid losses, transformer and cable impact costs, daily peak load forecasts, and annual integrated load profiles. The GUI may also support features which allow a user to select one or more electro-technologies of interest, and customize the types of simulations performed and/or information displayed based on the selected electro-technologies (e.g., see the GUI 65 of FIG. 2E).

Method 100 may be implemented by computers, including servers and dedicated digital processing systems, executing one or more modules of software code and/or by components of computing hardware. For example, one or more modules of computer-readable instructions may be stored in a memory device and executable by a processor to perform the steps of method 100. The servers may be in communication with one or more databases storing the historical data and/or forecasted data used in method 100.

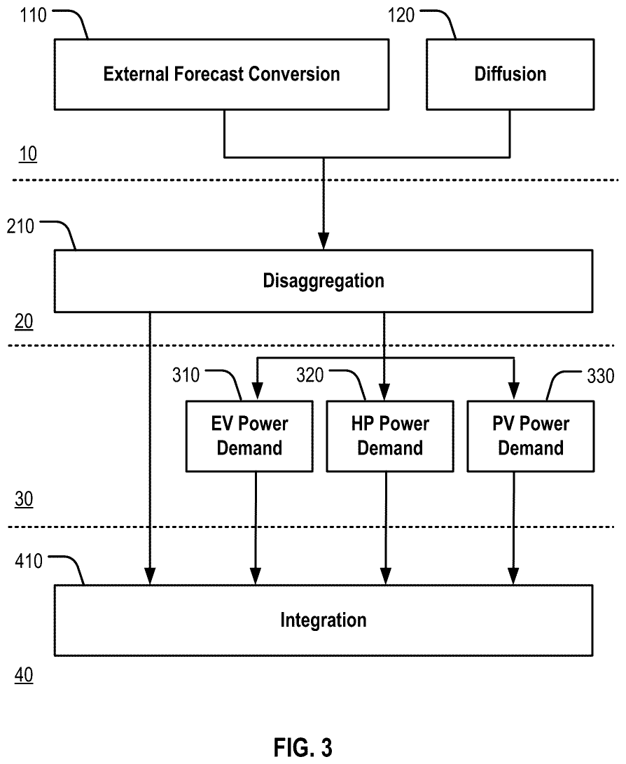

Referring now to FIG. 3, shown therein is a block diagram of various exemplary modules that may be provided as part of a computing system or otherwise configured to implement method 100. External forecast conversion module 110, diffusion module 120, and/or other dedicated modules of the like may be used to implement technology deployment estimation step 10. Disaggregation module 210 and/or other dedicated modules of the like may be used to implement geospatial distribution step 20. EV power demand module 310, HP power demand module 320, PV output module 330, and/or other dedicated modules of the like may be used to implement energy forecasting step 330. Integration module 40 and/or other dedicated modules of the like may be used to implement integration step 40.

External forecast conversion module 110 is configured to convert emerging technology adoption forecasts conducted at regional levels (e.g., provincial or state level) down to utility area-levels. Module 110 may rely on historical information, publicly available forecasts, and/or forecasts generated from performing supplementary calculations on publicly available forecasts. Module 110 may be configured to receive as input both forecasted data and historical data.

Module 110 may be used in connection with technologies like electrical vehicles (EV) and heat pumps (HPs). For example, module 110 may be provided and used in some embodiments to determine how the widespread adoption of EVs and HPs within an entire geographic region would affect power consumption in one or more target utility areas. In such embodiments, the forecasted data provided to module 110 may include data obtained from external databases, such as a forecasted number of EVs in a region over a predetermined period of time (e.g., 10 years), the region's forecasted end-use prices under the scenario of current policies adopted by applicable government regulators, and forecasted space heating stock data obtained from databases providing overviews of sectoral energy markets in various regions of a country (e.g., Canada's Comprehensive Energy Use Database). In such embodiments, the historical data provided to module 110 may include data obtained from historical databases, such as total historical EV registrations within a region over a period of time, total historical heat pump installations within a region over a period of time, etc.

In some embodiments, module 110 implements technology deployment estimation step 10 via a multi-step process. As an example, the process may involve a first step of estimating a target utility area's technology adoption rates in a given year or other predetermined time period, followed by a second step of applying the target utility area's estimated adoption rates to the target utility area's market size to obtain an estimated technology adoption count within the target utility area.

For electric vehicle and heat pump adoption, a target utility area's adoption rates may be estimated in accordance with, for example, the following:

$${AR}_{EV / {HP}_{{UA}_{t}}} = {AR}_{EV / {HP}_{{UA}_{t - 1}}} + ( 1 - {AR}_{EV / {HP}_{{UA}_{t - 1}}} ) \times \frac{{AR}_{EV / {HP}_{{P}_{t}}} - {AR}_{EV / {HP}_{{P}_{t - 1}}}}{1 - {AR}_{EV / {HP}_{{P}_{t - 1}}}} \qquad ( 1 )$$

where

$${AR}_{EV / {HP}_{{UA}_{t}}}$$

corresponds to a target utility area's adoption rate for EVs/HPs over a predetermined time period “t”,

$${AR}_{EV / {HP}_{{UA}_{t - 1}}}$$

corresponds to a target utility area's adoption rate for EVs/HPs in the previous time period “t−1”,

$${AR}_{EV / {HP}_{{P}_{t}}}$$

corresponds to the regional adoption rates of EVs/HPs (e.g., the rate of adoption in an entire state or province) in time period “t”, and

$${AR}_{EV / {HP}_{{P}_{t - 1}}}$$

corresponds to the regional adoption rates of EVs/HPs in the previous time period “t−1”.

A forecasted total number of EVs/HPs adopted within the target utility area over a predetermined period of time may then be calculated by applying the estimated EV/HP adoption rates within a target utility area to the EV/HP market size in the target utility area in accordance with, for example, the following:

$${S}_{EV / {HP}_{{UA}_{t}}} = {AR}_{EV / {HP}_{{UA}_{t}}} \times {MS}_{EV / {HP}_{{UA}_{t}}} \qquad ( 2 )$$

where

$${S}_{EV / {HP}_{{UA}_{t}}}$$

corresponds to a total stock of EVs/HPs expected to be deployed within the target utility area in time period “t”,

$${AR}_{EV / {HP}_{{UA}_{t}}}$$

corresponds to the estimated EV/HP adoption rates within a target utility area in time period “t”, and

$${MS}_{EV / {HP}_{{UA}_{t}}}$$

corresponds to the market size of EVs/HPs in the target utility area in time period “t”.

The output

$${S}_{EV / {HP}_{{UA}_{t}}}$$

may be converted by module 110 into an estimated rate of deployment for EVs/HPs in the target utility area. The estimated rate of deployment of EVs may reflect, for example, an estimated annual number of passenger EVs adopted in the target utility area for the next year. The estimated rate of deployment of HPs may reflect, for example, an estimated annual number of residential heat pumps adopted in the target utility area for the next year.

For other types of emerging electro-technologies, diffusion module 120 may be used and configured to generate technology adoption forecasts at more granular geospatial levels than the target utility area. For example, module 120 may be configured to generate emerging technology adoption forecasts at a postal code level of granularity, such as the forward sortation area (FSA) level of granularity (e.g., 3-digit postal code level for Canadian cities). Like external forecast conversion module 110, diffusion module 120 may be configured to receive as input external data and/or historical data.

Module 120 may incorporate one or more econometric models, such as the Bass diffusion model, to account for the fraction of a market that has adopted a new technology compared to the overall size of the market. Such diffusion models may be calibrated for a specific market of interest and may incorporate the concept of innovators (i.e., those who initially purchase the technology) and imitators (i.e., those who purchase the product because of interactions with those who already own the product, as a driving force of adoption).

In some embodiments, module 120 implements technology deployment estimation step 10 via a multi-step process. As an example, the process implemented by module 120 may involve a first step of estimating an FSA's technology adoption rate, followed by a second step of applying the estimated FSA technology adoption rate to the FSA technology market size to obtain an estimated technology adoption count within the FSA.

In some embodiments, module 120 is used in connection with emerging electro-technologies like photovoltaics (PV). For example, module 120 may be configured to determine how the widespread adoption of photovoltaics within an FSA would affect power consumption in one or more utility areas related to the FSA. In such embodiments, the types of data provided to module 120 may include current levels of technology adoption at the FSA level, the FSA technology market size, data obtained from a Distributed Generation Market Demand (dGen) model, etc.

For PV adoption, an FSA's adoption rate may be estimated in accordance with, for example, the following:

$${AR}_{{PV}_{{FSA}_{t}}} = \frac{1 - {e}^{- ( p + q ) t}}{1 + \frac{q}{p} {e}^{- ( p + q ) t}} \qquad ( 3 )$$

where

$${AR}_{{PV}_{{FSA}_{t}}}$$

corresponds to an FSA's adoption rate in a predetermined time period “t”, p corresponds to a coefficient of innovators, q corresponds to a coefficient of imitators, and t corresponds to the time period “t”. The coefficient of innovators and the coefficient of imitators may be calibrated dynamically in some cases according to the specific market of interest.

A forecasted total number of PVs adopted within the FSA over a predetermined period of time may then be calculated by applying the PV adoption rate within an FSA to the PV market size in the FSA in accordance with, for example, the following:

$${S}_{{PV}_{{FSA}_{t}}} = {AR}_{{PV}_{{FSA}_{t}}} \times {MS}_{{PV}_{{FSA}_{t}}} \qquad ( 4 )$$

### Where

$${S}_{{PV}_{{FSA}_{t}}}$$

corresponds to a total stock of PVs expected to be deployed within the FSA in time period “t”,

$${AR}_{{PV}_{{FSA}_{t}}}$$

corresponds to the calculated PV adoption rate within the FSA in the time period “t”, and

$${MS}_{{EV}_{{FSA}_{t}}}$$

corresponds to the market size of PVs in the FSA in the time period “t”.

The output

$${S}_{{PV}_{{FSA}_{t}}}$$

may be converted by diffusion module 120 into an estimated rate of deployment of PVs in a target utility area (e.g., by summing the PV adoption in each FSA within the target utility area). The estimated rate of deployment of PVs may reflect, for example, an estimated annual number of PVs adopted in the target utility area for the next year.

As depicted in FIG. 3, the outputs of modules 110, 120 may be provided to disaggregation module 210 for further processing. Disaggregation module 210 is configured to implement geospatial distribution step 20 through a top-down approach. Disaggregation module 210 predicts how emerging technologies, such as EVs, heat pumps, and PVs, will be distributed across a target utility area's circuits and substations. Disaggregation module 210 may incorporate one or more linear regression models. The models may be trained or otherwise configured with census data in conjunction with past technology adoption numbers collected at the FSA level.

Disaggregation module 210 receives data from external forecast conversion module 110, diffusion module 120, and/or external sources. In particular, disaggregation module 210 may receive as input the estimated rate of deployment or adoption count of newly adopted technologies (e.g., EVs, heat pumps, PVs, etc.) for a future time period, historical adoption counts and deployment rates for such technologies, census data, utility data, and region-specific data. Region-specific data may include, for example, a list of dissemination areas (DAs) in the target utility area, a list of FSAs in the target utility area, etc. Utility data may include, for example, a current number of EVs, PVs, and heat pumps in FSAs, etc. Disaggregation module 210 may be configured to predict the stock of newly adopted technologies at both the circuit and substation level for current and future years. Disaggregation module 210 may also be configured to predict the stock of newly adopted technologies at both the FSA and DA level for current and future years.

In some embodiments, disaggregation module 210 implements geospatial distribution step 20 via a multi-step process. The process may involve a first step of determining the number of new technology adoptions to be disaggregated, followed by a second step of calculating the proportion of technology adoption attributable to certain DAs or FSAs of interest, followed by a final step of applying the total number of new technology adoptions to the proportion of technology adoption attributable to the DA or FSA of interest.

In the first step of the exemplary process, the number of new technology adoptions to be disaggregated at future points in time is calculated by subtracting the number of existing adoptions at the forecasted level of geospatial granularity (e.g., target utility area for HP and EV, FSA for PV) in the previous time period “t−1” from the forecasted number of new electro-technologies at the forecasted level of geospatial granularity in the time period “t”. For EV, HP, and PV adoption, the total number of new adoptions of each technology in year “t” may be determined in accordance with, for example, the following:

$$Δ {S}_{{EV}_{{UA}_{t}}} = {S}_{{EV}_{{UA}_{t}}} - {S}_{{EV}_{{UA}_{t - 1}}} \qquad ( 5 )$$

$$Δ {S}_{{HP}_{{UA}_{t}}} = {S}_{E {V}_{{UA}_{t}}} - {S}_{{EV}_{{UA}_{t - 1}}}$$

$$Δ {S}_{{PV}_{{FSA}_{t}}} = {S}_{{PV}_{{FSA}_{t}}} - {S}_{{PV}_{{FSA}_{t - 1}}}$$

where

$$Δ {S}_{{EV}_{{UA}_{t}}} , Δ {S}_{{HP}_{{UA}_{t}}} , Δ {S}_{{PV}_{{FSA}_{t}}}$$

correspond to the number of new technologies to be disaggregated in time period “t”,

$${S}_{{EV}_{{UA}_{t}}} , {S}_{{EV}_{{UA}_{t}}} , {S}_{{PV}_{{FSA}_{t}}}$$

correspond to the forecasted technology adoption count in time period “t” derived from step 10, and

$${S}_{{EV}_{{UA}_{t - 1}}} , {S}_{{EV}_{{UA}_{t - 1}}} , {S}_{{PV}_{{FSA}_{t - 1}}}$$

correspond to the forecasted technology adoption count in previous time period “t−1” derived from step 10.

In the second step of the exemplary process, the proportion of technology adoption attributable to certain DAs is determined. The proportion may be calculated by dividing an estimated number of a specific technology in the DA by an estimated total number of a specific technology in the target utility area or FSA in accordance with, for example, the following:

$${P}_{EV / HP / {PV}_{{DA}_{k}}} = \frac{{ES}_{EV / HP / {PV}_{{DA}_{k}}}}{{\sum }_{k = 1}^{n} {ES}_{EV / HP / {PV}_{{DA}_{k}}}} \qquad ( 6 )$$

where

$${P}_{EV / HP / {PV}_{{DA}_{k}}}$$

is the proportion of technology adoption attributable to a certain DA, relative to the target utility area, and

$${ES}_{EV / HP / {PV}_{{DA}_{k}}}$$

is the estimated number of technology (e.g., EV, HP, PV) in a specific DA “k” within the target utility area (e.g., for EVs and HPs) or FSA (e.g., for PVs). The estimated number of each technology in a specific DA may be determined by establishing a relationship between census data and historic adoption rates. Examples of the types of census attributes that may be used to establish such a relationship include, but not limited to, household income, dwelling type, building age, etc.

In the third and final step of the exemplary process, the total stock of the electro-technology of interest is determined by applying the total number of new technology adoptions to the proportion of technology adoption in accordance with, for example, the following:

$${S}_{{EV}_{{DA}_{{k}_{t}}}} = {S}_{{EV}_{{DA}_{{k}_{t - 1}}}} + ( Δ {S}_{{EV}_{{UA}_{t}}} \times {P}_{{EV}_{{DA}_{k}}} ) \qquad ( 7 )$$

$${S}_{{HP}_{{DA}_{{k}_{t}}}} = {S}_{{HP}_{{DA}_{{k}_{t - 1}}}} + ( Δ {S}_{{HP}_{{UA}_{t}}} \times {P}_{{HP}_{{DA}_{k}}} )$$

$${S}_{{PV}_{{DA}_{{k}_{t}}}} = {S}_{{PV}_{{DA}_{{k}_{t - 1}}}} + ( Δ {S}_{{PV}_{{FSA}_{t}}} \times {P}_{{PV}_{{DA}_{k}}} )$$

where

$${S}_{{EV}_{{DA}_{{k}_{t}}}} / {S}_{{HP}_{{DA}_{{k}_{t}}}} / {S}_{{PV}_{{DA}_{{k}_{t}}}}$$

are the technology adoption counts in a DA “k” in the time period “t”, and

$${S}_{{EV}_{{DA}_{{k}_{t - 1}}}} / {S}_{{HP}_{{DA}_{{k}_{t - 1}}}} / {S}_{{PV}_{{DA}_{{k}_{t - 1}}}}$$

are the technology adoption counts in a DA “k” in the previous time period “t−1”.

Various modules may be used to implement load forecasting step 30 of method 100. The modules may be configured according to the specific type of technology adopted. In the example depicted in FIG. 3, an EV power demand module 310 is configured to assess the load and generation impact of EV adoption, an HP power demand module 320 is configured to assess the load and generation impact of heat pump adoption, and a PV power demand module 330 is configured to assess the load and generation impact of PV adoption. As depicted in FIG. 3, modules 310, 320, 330 may each receive data from disaggregation module 210 and/or external sources.

To assess the load and generation impact of EVs, module 310 may generate EV load profiles theoretically or using measured EV load data. To generate EV load profiles theoretically, module 310 may be configured to create one or more sets of potential load profiles representing a variety of different EV characteristics and charging behaviours. Such theoretical load profiles may be based or dependent on factors including: common energy battery sizes in EVs, various power rating or levels of EV charger, State of Charge (SOC) when commencing a charge, time and duration of charge, and likelihood of charging each day. A relative weighting of each potential load profile in the set may be determined by module 310. The relative weighting of each potential load profile may be determined by, for example, identifying relative propensities of the previously mentioned factors in the EV market, or by establishing a linear combination of potential load profiles to an aggregate EV load profile across multiple EVs.

To generate EV load profiles using measured EV load data, module 310 may be configured to create one or more sets of potential EV load profiles by, for example, directly measuring the load profiles of EVs while charging. Module 310 may also be configured to create the one or more sets by, for example, decomposing hourly net loads at electricity meters into an EV specific load. Such net loads may include non-EV loads such as space heating, space cooling, water heating, lighting, etc.

To assess the electrical load impact of HPs, module 320 may generate aggregate HP load profiles theoretically or individual HP load profiles using measured load data from HPs. To generate aggregate HP load profiles theoretically, module 320 may be configured to forecast load demands based on one or more performance indicators, such as an estimated coefficient of performance (COP) indicator and an operating cycle indicator. The coefficient of performance refers to a ratio of useful heating (or cooling) energy divided by the total work or energy required to produce the useful heating (or cooling). Both the estimated COP and operating cycle indicators may be dependent on temperature-related factors.

In some embodiments, module 320 is configured to calculate the maximum running wattage for HPs in a selected area at temperatures above a threshold. The threshold may be selected or set by module 320 as, for example, −15° C. (258K). For the purposes of facilitating the description, it is assumed that heat pumps generally have an electric resistance heater as a backup that begins operating at temperatures below a threshold. At temperatures above the threshold, the load requirement corresponds to the load from the heat pump; at temperatures below the threshold, the total load requirement corresponds to the sum of the load from the heat pump (assumed to be operating at the threshold temperature) as well as the load from the electric resistance heater (assumed to have a COP of 1 given that electric resistance heaters converts 100% of electric energy into heat).

Based on assumptions above and for the size of the heat pump outlined in the assumptions section below, the maximum running wattage of an HP may be calculated in accordance with, for example, the following:

$${P}_{{max}_{x}} = \frac{( \frac{{P}_{{hp}_{{out}_{x}}}}{H S P {F}_{{T}_{out}}} )}{1 , 000} \qquad ( 8 )$$

where Pₘₐₓ_{ₓ} is the average heat pump output in a specified area x,

$${P}_{{hp}_{{out}_{x}}}$$

BTU in the specified area x, and HSPF_{T}_{ₒᵤₜ} is the heating seasonal performance factor (HSPF) of the heat pump.

The HSPF rating measures a heat pump's efficiency. While HSPF is typically calculated using the average outdoor temperature of a given cold season, it can also be calculated on an hourly basis as a function of actual outside temperature. As an example, the HSPF rating may be calculated in accordance with, for example, the following:

$$H S P F = \frac{0.6 \; 24 \pm \sqrt{0.389376 - 0.104 \times C O P}}{0.052} \qquad ( 9 )$$

where COP is the coefficient of performance of the heat pump.

The coefficient of performance (COP) for a heat pump may be dependent on the desired indoor temperature (e.g., 21° C., or 294 Kelvin, for heating), the outside temperature (Tₒᵤₜ), and the technical capabilities of the heat pump. As an example, the COP for certain heat pump models may be determined in accordance with, for example, the following

$$C O P ( {T}_{out} ) = \{ \begin{matrix}3.84 , & {T}_{out} \geq 281 K \\ ( 0.1062 ) ( {T}_{out} ) - 26.032 , & 265 K \leq {T}_{out} \geq 281 K \\ ( 0.02 ) ( {T}_{out} ) - 3.163 , & 258 K \leq {T}_{out} \geq 265 K \\ 2 , & {T}_{out} \geq 258 K\end{matrix} \qquad ( 10 )$$

where Tₒᵤₜ is the outside temperature.

With the maximum running wattage of HPs in a selected area, the total load of all the HPs in a specified area can be calculated based on the percent of HP units operating at 100% in a given hour. As an example, the total hourly power wattage in a selected “i” hour in hour can be calculated in accordance with, for example, the following:

$${P}_{total {x}_{i}} = {P}_{max {x}_{i}} * {n}_{{HP}_{x}} * C {F}_{{HP}_{x}} \qquad ( 11 )$$

where, P_{max x}_{ᵢ} is the average heat pump output in specified area “x” at hour “i”, which is dependent on the outside temperature for that hour, n_{HP}_{ₓ} is the number of heat pumps in area x, and CF_{HP}_{ₓ} is a capacity factor corresponding to the percent of heat pumps on at the same time in a specified area. The capacity factor may be selected or otherwise defined to indicate that the heat pump has a reduction in heating capacity at −15° C., is operating at 100% at temperatures below −15° C., is not operating at 21° C. for 75% of the time, and follows a linear relationship between −15°° C. and 21° C.

To generate individual HP load profiles using measured load data from HPs, module 320 may be configured to create a set of potential individual HP load profiles by, for example, directly measuring the load profiles of HPs in operation. Module 320 may also be configured to create the set by, for example, decomposing hourly net loads at electricity meters into an HP specific load. Such net loads may include non-HP loads, such as electric baseboards, air conditioning units, EVs, water heating, lighting, etc.

To assess the power generation impact of PVs, module 330 may be configured to apply one or more econometric models (e.g., models similar to the National Renewable Energy Laboratory's PVWatts™ Solar PV Model) to estimate the hourly power output of current and future solar photovoltaic installations in the target utility area. Such models may account for both residential PV archetypes (e.g., fixed units found on the roofs of individual homes) and commercial archetypes (e.g., fixed open arrays found on the roofs of commercial buildings).

The average solar output is based on the power the PV units provide, which may be dependent on the direction they face. The weighted average of solar panels across a specified area may be calculated in accordance with, for example, the following:

$${P}_{{avg}_{xi}} = {( {P}_{E} * {c}_{E} )}_{i} + {( {P}_{SE} * {c}_{SE} )}_{i} + {( {P}_{S} * {c}_{S} )}_{i} + {( {P}_{SW} * {c}_{SW} )}_{i} + {( {P}_{W} * {c}_{W} )}_{i} \qquad ( 12 )$$

where P_{H} is the power output at heading “H” (e.g., E, SE, S, SW, W, etc.), and c_{H} is a weight factor corresponding to the percentage of solar panels in the specified area pointed in the H heading direction.

In some embodiments, module 330 is configured to account for the size of the solar system, which may be defined herein as the net power output of the system measured in units of kW. For a given area within a target utility area, the average size of a solar system may be estimated by analyzing rooftop sizes within the area of interest.

Integration module 410 may be used to implement integration step 40 of method 100. Integration module 410 is configured to determine the overall load impact of the new technology adoptions on the electrical grid of the target utility area. Integration module 410 receives, as input, data from modules 210, 310, 320, 330 and/or external sources.

Integration module 410 may be configured to generate new technology load forecasts and/or net load forecasts at varying levels of geospatial granularity from the present day to a future year. In some embodiments, integration module 410 is configured to disaggregate the DA-level adoption counts determined by module 210 to meter-level counts. The disaggregation process may be conducted via probabilistic and/or stochastic methods. As an example, a probabilistic disaggregation may involve Monte Carlo simulations to reduce uncertainty in results.

To generate the technology load profiles, integration module 410 probabilistically and/or deterministically assigns the load profiles from modules 310, 320, and 330 to the technology adoption count at a selected level of geospatial granularity. In cases where multiple technologies have been forecasted, multiple load profiles may be assigned by module 410.

Integration module 410 may, optionally, perform further aggregation or disaggregation operations on the forecasted technology net loads. For example, integration module 410 may distribute the forecasted load profiles along assets in the electricity infrastructure, such as meters, transformers, substations, etc. Integration module 410 may also, optionally, aggregate or disaggregate the forecasted technology net loads to geographic levels, such as DA, FSA, utility area, city, province, country.

In some embodiments, integration module 410 is configured to conduct a comparative analysis between forecasted net loads and electricity infrastructure asset technical specifications. Such analysis may highlight electricity infrastructure assets that will be non-compliant with rated asset specifications. In some embodiments, integration module 410 is configured to overlay new technology load with base load projections (i.e., existing load without modelled technologies) to assess the net load applied to components within the target utility area. The outputs of integration module 410, including any raw data, intermediate data or overlaid data, may be rendered and displayed in one or more display areas of a GUI in the form of charts, plots, graphs, tables, etc. (e.g., see FIG. 2).

The examples and corresponding diagrams used herein are for illustrative purposes only. Different configurations and terminology can be used without departing from the principles expressed herein.

Although the invention has been described with reference to certain specific embodiments, various modifications thereof will be apparent to those skilled in the art without departing from the scope of the invention. The scope of the claims should not be limited by the illustrative embodiments set forth in the examples, but should be given the broadest interpretation consistent with the description as a whole. For example, various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

1. A computer-implemented method for assessing the effects of an adopted electro-technology on power demands on an electrical grid, the method comprising:
receiving forecasted and historical data for the adopted electro-technology;
based on the forecasted and historical data, estimating a rate of deployment for the adopted electro-technology in a target utility area over a predetermined time period;
estimating a total stock of the adopted electro-technology in one or more dissemination areas by geospatially disaggregating the estimated rate of deployment of the adopted electro-technology across the one or more dissemination areas;
deriving from the estimated total stock of the adopted electro-technology a forecasted energy consumption profile for one or more subareas within the target utility area; and
integrating the forecasted energy consumption profiles with current consumption profiles for display in a graphical user interface.

2. The method according to claim 1, comprising estimating the rate of deployment of the adopted electro-technology via one or more deployment models.

3. The method according to claim 2, comprising periodically updating the one or more deployment models.

4. The method according to claim 2, comprising classifying the adopted electro-technology, and estimating the rate of deployment of the adopted electro-technology based on a deployment model selected via the classification of the adopted technology.

5. The method according to claim 1, wherein the estimated rate of deployment for the adopted electro-technology is determined from an estimated increase in total stock of the adopted electro-technology in the target utility area over the predetermined time period.

6. The method according to claim 1, wherein the dissemination areas are defined according to behavioral data and geospatial data collected from within parts of the target utility area.

7. The method according to claim 1, wherein the one or more subareas area are defined on a circuit level or a substation level.

8. The method according to claim 1, wherein the target utility area is defined on a city level or a postal code level.

9. The method according to claim 1, comprising overlaying the integrated forecasted energy consumption profile onto a digital model of the electrical grid.

10. The method according to claim 1, wherein the forecasted energy consumption profile is derived from the estimated total stock of the adopted electro-technology based on a bottom-up circuit-level load forecast approach or a bottom-up substation-level load forecast approach.

11. A system for assessing the effects of an adopted electro-technology on power demands on an electrical grid, the system comprising a server, wherein the server is in communication with a database and is configured to:
receive, from the database, forecasted and historical data on the adopted electro-technology;
based on the forecasted and historical data, estimate a rate of deployment for the adopted electro-technology in a target utility area over a predetermined time period;
estimate a total stock of the adopted electro-technology in one or more dissemination areas by geospatially disaggregating the estimated rate of deployment of the adopted electro-technology across the one or more dissemination areas;
derive from the estimated total stock of the adopted electro-technology a forecasted energy consumption profile for one or more subareas within the target utility area; and
integrate the forecasted energy consumption profiles with current consumption profiles for display in a graphical user interface.

12. The system according to claim 11, wherein the server is configured to estimate the rate of deployment of the adopted electro-technology based on one or more deployment models.

13. The system according to claim 12, wherein the server is configured to periodically update the one or more deployment models.

14. The system according to claim 12, wherein the server is configured to classify the adopted electro-technology and estimate the rate of deployment of the adopted electro-technology based on a deployment model selected via the classification of the adopted electro-technology.

15. The system according to claim 11, wherein the estimated rate of deployment for the adopted electro-technology is determined from an estimated increase in total stock of the adopted electro-technology in the target utility area over the predetermined time period.

16. The system according to claim 11, wherein the dissemination areas are defined according to behavioral data and geospatial data collected from within parts of the target utility area.

17. The system according to claim 11, wherein the one or more subareas area are defined on a circuit level or a substation level.

18. The system according to claim 11, wherein the target utility area is defined on a city level or a postal code level.

19. The system according to claim 11, wherein the server is configured to overlay the integrated forecasted energy consumption profile onto a digital model of the electrical grid.

20. The system according to claim 11, wherein the forecasted energy consumption profile is derived from the estimated total stock of the adopted electro-technology based on a bottom-up circuit-level load forecast approach or a bottom-up substation-level load forecast approach.
